(19) United States
(12) Patent Application Publication
(10) Pub. No.: US 2026/0220409 A1
(43) Pub. Date: Jul. 30, 2026

(54) NON-TRANSITORY COMPUTER-READABLE STORAGE MEDIUM STORING COMPUTER-READABLE INSTRUCTIONS FOR TERMINAL DEVICE, PRINTER, AND COMMUNICATION SYSTEM

(71) Applicant: BROTHER KOGYO KABUSHIKI KAISHA, Nagoya (JP)

(72) Inventor: Hiromu SUZUKI, Nagoya (JP)

(21) Appl. No.: 19/463,985

(22) Filed: Jan. 29, 2026

(30) Foreign Application Priority Data
Jan. 30, 2025 (JP) 2025-014020

(51) Int. Cl. G06K 15/02; G06F 3/12

(52) U.S. Cl. CPC G06K 15/1809; G06F 3/1203; G06F 3/1259

(57) ABSTRACT

A non-transitory computer-readable storage medium storing computer-readable instructions for a terminal device, the computer-readable instructions, when executed by a processor of the terminal device, cause the terminal device to, in a case where a print preparation process is started in a printer, receive start information indicating start of the print preparation process from the printer. The computer-readable instructions, when executed by the processor, cause the terminal device to, in a case where the start information is received from the printer, cause a terminal display unit to display an information input screen for input of subscription information, the subscription information being used to subscribe to a predetermined service which is related to the printer. The computer-readable instructions, when executed by the processor, cause the terminal device to, in a case where the subscription information is inputted in the information input screen, send the subscription information to a server.

### SPECIFICATION

### REFERENCE TO RELATED APPLICATION

This application claims priority to Japanese Patent Application No. 2025-014020 filed on January 30, 2025. The entire content of the priority application is incorporated herein by reference.

### BACKGROUND ART

A technology for prompting a user to subscribe to a printer-related service is known. In this technology, a printer displays a message prompting subscription to the service when executing a print preparation process.

### SUMMARY

The disclosure herein provides a technology that can improve user convenience.

A non-transitory computer-readable storage medium storing computer-readable instructions for a terminal device is disclosed herein. The terminal may include a terminal display unit and a processor. The computer-readable instructions, when executed by the processor, may cause the terminal device to, in a case where a print preparation process is started in a printer, receive start information indicating start of the print preparation process from the printer. The computer-readable instructions, when executed by the processor, may cause the terminal device to, in a case where the start information is received from the printer, cause the terminal display unit to display an information input screen for input of subscription information, the subscription information being used to subscribe to a predetermined service which is related to the printer. The computer-readable instructions, when executed by the processor, may cause the terminal device to, in a case where the subscription information is inputted in the information input screen, send the subscription information to a server.

According to the configuration above, in response to receiving the start information from the printer, which indicates the start of the print preparation process, the terminal device displays the information input screen for input of subscription information. In response to subscription information being inputted in the information input screen, the terminal device sends the subscription information to the server. Generally, the print preparation process takes a certain amount of time from its start to end. Since the information input screen is displayed while the print preparation process is being executed, the user can input subscription information while waiting

for the print preparation process to end. Thus, user convenience can be improved.

A printer is also disclosed herein. The printer may include a print executing unit, a printer display unit, and a controller. The controller may be configured to cause the print executing unit to execute a print preparation process. The controller may be configured to, in a case where the print preparation process is started by the print executing unit, cause the printer display unit to display an introduction screen for introduction of a predetermined service which is related to the printer. The controller may be configured to, in the case where the print preparation process is started by the print executing unit, send start information indicating start of the print preparation process to a terminal device, wherein the start information is used to cause a terminal display unit of the terminal device to display an information input screen for input of subscription information, the subscription information being used to subscribe to the predetermined service.

According to the configuration above, when starting the print preparation process, the printer displays the introduction screen for introduction of the predetermined service and sends the start information to the terminal device. In this case, the information input screen for input of subscription information is displayed on the terminal device. Generally, the print preparation process takes a certain amount of time from its start to end. Since the information input screen is displayed on the terminal device while the print preparation process is being executed, the user can input subscription information while waiting for the print preparation process to end. Further, the user can input subscription information after reviewing the introduction screen displayed on the printer. Thus, user convenience can be improved.

A communication system is also disclosed herein. The communication system may include a printer and a terminal device. The printer may include a printer display unit and a printer controller. The printer controller may be configured to cause the printer display unit to display an introduction screen for introduction of a predetermined service which is related to the printer. The terminal device may include a terminal display unit a terminal controller. The terminal controller may be configured to, in a case where information indicating display of the introduction screen on the printer display unit is received from the printer, cause the terminal display unit to display an information input screen for input of subscription information, the subscription information being used to subscribe to the predetermined service. The terminal controller may be configured to, in a case where the subscription information is inputted in the information input screen, send the subscription information to a server.

According to the configuration above, the printer displays the introduction screen for introduction of the predetermined service. Further, in response to receiving the information indicating the display of the introduction screen at the printer, the terminal device displays the information input screen for input of subscription information. In response to subscription

information being inputted in the information input screen, the terminal device sends the subscription information to the server. The user can input subscription information after reviewing the introduction screen displayed on the printer. Thus, user convenience can be improved.

Terminal devices implemented by the above computer-readable instructions and methods performed by the terminal devices are also novel and useful. Computer-readable instructions for the above printer, a non-transitory computer-readable storage medium storing the computer-readable instructions for printer, and methods performed by the printer are also novel and useful. The medium above may be a single medium or a combination of media.

### BRIEF DESCRIPTION OF DRAWINGS

FIG. 1 is a configuration diagram of a communication system.

FIG. 2 is a sequence diagram illustrating a process executed between devices.

FIG. 3 is a sequence diagram continued from FIG. 2.

FIG. 4 is a sequence diagram for Case A.

FIG. 5 is a sequence diagram continued from FIG. 4.

FIG. 6 is a sequence diagram continued from FIG. 5.

FIG. 7 is a sequence diagram for Case B.

FIG. 8 is a sequence diagram for Case C and Case C1.

FIG. 9 is a sequence diagram for Case C2.

FIG. 10 is a sequence diagram illustrating a process executed between devices.

### DESCRIPTION

### First Embodiment

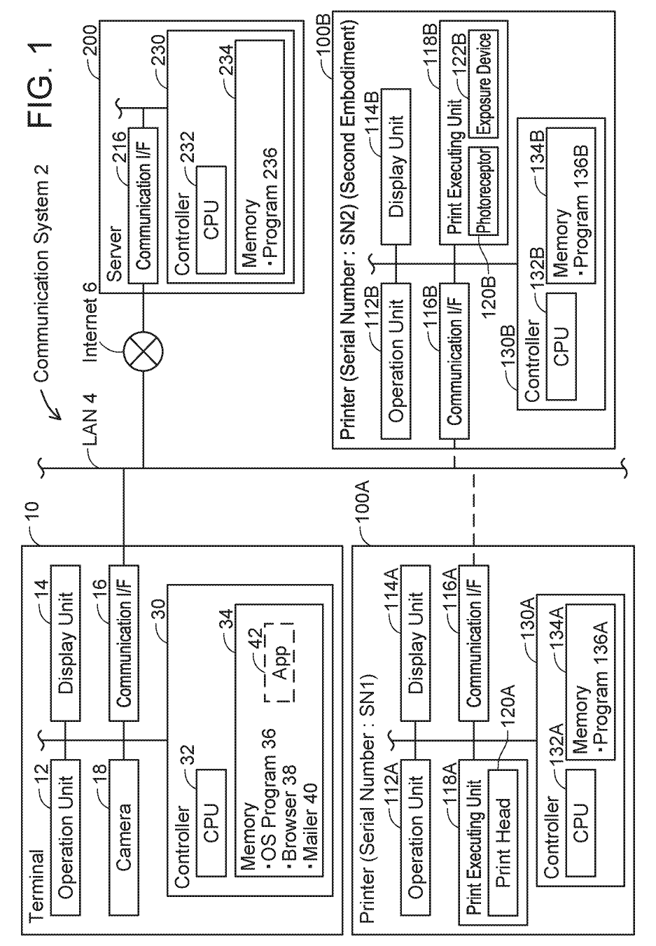

### Configuration of Communication System 2: FIG. 1

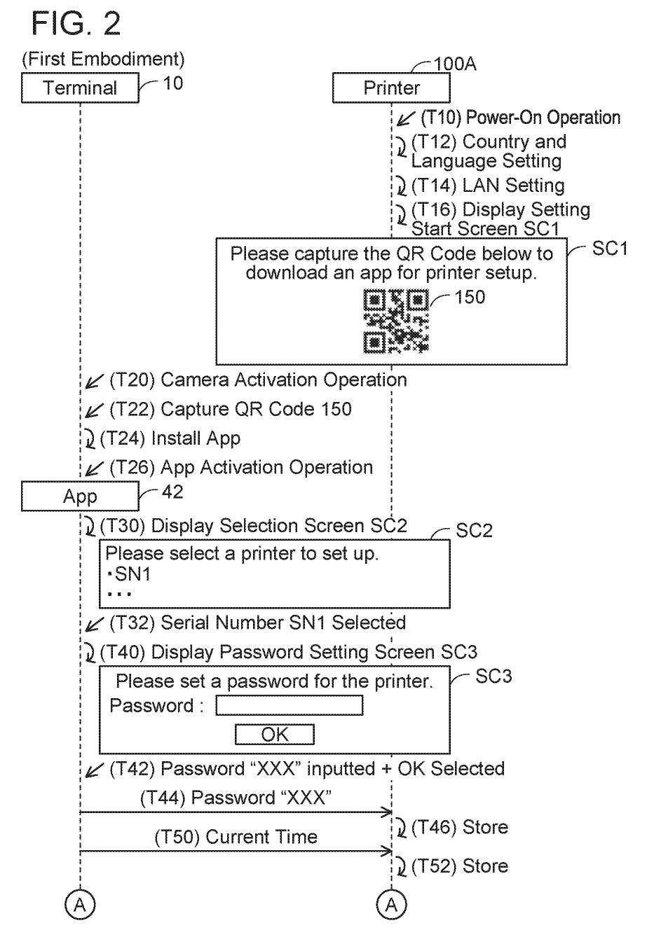

As illustrated in FIG. 1, a communication system 2 comprises a terminal 10, a printer 100A, and a server 200. The terminal 10 is connected to a local area network 4 (LAN 4). The LAN 4 may be a wired LAN or a wireless LAN. In this embodiment, it is assumed that a brand-new printer 100A is newly connected to the LAN 4. Once the printer 100A is connected to the LAN 4 (see T14 in FIG. 2), the terminal 10 and the printer 100A can communicate with each other via the LAN 4. Subsequently, a user uses the terminal 10 to perform an initial setting to bring the printer 100A into a printable state. This initial setting may be referred to as “setup” hereinafter.

The LAN 4 is connected to the internet 6. The server 200 is provided on the internet 6. The devices 10, 100A can communicate with the server 200 via the LAN 4 and the internet 6.

### Configuration of Terminal 10

The terminal 10 is a portable terminal device such as a mobile phone, a smartphone, a PDA, or a tablet PC. In a modification, the terminal 10 may be a stationary PC or a laptop PC.

The terminal 10 comprises an operation unit 12, a display unit 14, a communication interface 16, a camera 18, and a controller 30. The units 12 to 30 are connected to a bus line. Hereinafter, an interface is abbreviated as “I/F”.

The operation unit 12 is a user interface through which the user can input various information to the terminal 10. The operation unit 12 comprises, for example, a touch screen for displaying software keys (operation objects), hardware keys, or both of them. The hardware keys include, for example, buttons or switches. The display unit 14 is a display or a panel for displaying various information. The panel may or may not be a touch panel. The panel may be, for example, a liquid‑crystal panel or an organic EL panel. The communication I/F 16 is connected to the LAN 4. The camera 18 is a device configured to capture images of objects. In this embodiment, the camera 18 is used to capture a QR Code displayed on the printer 100A. QR Code is a registered trademark owned by DENSO WAVE INCORPORATED.

The controller 30 comprises a CPU 32 and a memory 34. The memory 34 comprises a main storage and an auxiliary storage. The main storage includes a RAM and a cache memory, although this is merely an example. The auxiliary storage includes a ROM, a flash memory, a solid state drive (SSD), a hard disk drive (HDD), or a combination thereof, although this is merely an example. An OS program 36, a browser program 38, and a mailer program 40 are stored in the auxiliary storage of the memory 34. Hereinafter, the OS program, the browser program, and the mailer program are referred to as “OS”, “browser”, and “mailer”, respectively.

As described in detail below, an application program 42 for setup is installed to the terminal 10 (see T24 in FIG. 2). The application program 42 is stored in the auxiliary storage of the memory 34. Hereinafter, the application program is referred to as “app”.

The OS 36 controls basic operations of the terminal 10. The browser 38 is a program for accessing a web server and displaying web pages. The mailer 40 is a program for sending and receiving emails. An email address MA used by the user is set in the mailer 40. The app 42 is downloaded, for example, from an internet server provided by the vendor of the printer 100A (which is referred to simply as “the vendor” hereinafter) and installed into the terminal 10. The CPU 32 executes various processes in accordance with programs loaded to the main storage from the auxiliary storage.

### Configuration of Printer 100A

The printer 100A is a peripheral device configured to execute a print function, such as a peripheral device of the terminal 10. In a modification, the printer 100A may be a multifunctional device configured to execute a scan function and/or a facsimile function in addition to the print function. A serial number SN1, which is identification information for identifying the printer 100A, is assigned to the printer 100A. The printer 100A comprises an operation unit 112A, a display unit

114A, a communication I/F 116A, a print executing unit 118A, and a controller 130A. The units 112A to 130A are connected to a bus line.

The operation unit 112A is a user interface through which the user can input various information to the printer 100A. The operation unit 112A comprises, for example, a touch screen for displaying software keys (operation objects), hardware keys, or both of them. The hardware keys include, for example, buttons or switches. The display unit 114A is a display or a panel for displaying various information. The panel may or may not be a touch panel. The panel may be, for example, a liquid‑crystal panel or an organic EL panel. The communication I/F 116A is connected to the LAN 4.

The print executing unit 118A comprises an inkjet print engine. The print executing unit 118A comprises a print head 120A. The print head 120A is used to print letters and images on print paper. The print executing unit 118A is configured to allow an ink cartridge containing ink therein to be detachably attached thereto. The print executing unit 118A executes printing by using the ink in the ink cartridge. At the time of shipment of the printer 100A and while the printer 100A is on sale, no ink cartridge is mounted on the print executing unit 118A. Further, at the time of shipment of the printer 100A and while the printer 100A is on sale, the print head 120A is filled with a priming liquid having higher viscosity than the ink in order to prevent the print head 120A from drying out.

The controller 130A comprises a CPU 132A and a memory 134A. The memory 134A comprises a main storage and an auxiliary storage. The main storage includes a RAM and a cache memory, although this is merely an example. The auxiliary storage includes a ROM, a flash memory, an SSD, an HDD, or a combination thereof, although this is merely an example. A program 136A is stored in the auxiliary storage of the memory 134A. The CPU 132A executes various processes in accordance with programs loaded to the main storage from the auxiliary storage.

### Configuration of Server 200

The server 200 is provided on the internet 6 by the vendor. The server 200 may be a physical server or a virtual server or a virtual machine on the cloud. The server 200 may be a single server or a combination of multiple servers. The server 200 may be a server on an intranet or a cloud server on the internet 6. In a modification, the server 200 may be provided on the internet 6 by a business operator different from the vendor. In another modification, the vendor may not prepare hardware for the server 200 on its own and may use an environment provided by an external cloud computing service. In that case, the vendor may prepare a program (i.e., software) for the server 200 and realize the server 200 by introducing the program to the aforementioned environment. In this embodiment, the server 200 is a physical server, although this is merely an example.

The server 200 provides a subscription service available to the printer 100A. The subscription service includes an automatic shipping service of ink cartridge and a flat-rate print service. The automatic shipping service is a service of automatically shipping a new ink cartridge upon the amount of remaining ink in the currently mounted ink cartridge on a printer (e.g., 100A) satisfying a predetermined condition. Here, the “predetermined condition” includes, for example, that the amount of remaining ink is equal to or less than a predetermined threshold or that the remaining ink is expected to run out in a predetermined number of days. The flat-rate print service is a service that permits printing on a predetermined number of print media (e.g., 1000 sheets) or fewer within a predetermined period (e.g., one month) for a fixed fee. If printing is executed on print media beyond the upper limit within the predetermined period, an additional fee, which is calculated by multiplying an additional fee per print medium (e.g., 10 yen) by the number of excess print media, is charged.

The server 200 comprises a communication I/F 216 and a controller 230. The units 216, 230 are connected to a bus line. The communication I/F 216 is connected to the internet 6. The controller 230 comprises a CPU 232 and a memory 234. The memory 234 comprises a main storage and an auxiliary storage. The main storage includes a RAM and a cache memory, although this is merely an example. The auxiliary storage includes a ROM, a flash memory, an SSD, an HDD, or a combination thereof, although this is merely an example. A program 236 is stored in the auxiliary storage of the memory 234. The CPU 232 executes various processes in accordance with programs loaded to the main storage from the auxiliary storage.

### Process Executed Between Devices: FIG. 2

Now referring to FIG. 2, a process executed between the devices is described. Hereinafter, for ease of understanding, steps executed by the CPUs (e.g., 32, 132A, 232) of the devices (e.g., the terminal 10, the printer 100A) are described as if the devices themselves, rather than the CPUs, execute the steps. However, for steps executed by the CPU 32 of the terminal 10 executing the programs 36 to 42, these steps are described as if the programs 36 to 42 themselves, rather than the terminal 10, execute the steps. Further, communications between the devices are via the communication I/Fs (e.g., 16, 116A, 216). Therefore, in the following description, the phrase “via the communication I/F” is omitted when referring to communications.

In the initial state in FIG. 2, a brand-new printer 100A has just been installed. In T10, the printer 100A receives a power-ON operation from the user. In response, the printer 100A is turned on.

In T12, the printer 100A executes country and language settings. Specifically, the printer 100A first causes the display unit 114A to display a setting screen (not illustrated). The setting screen includes a selection region for selection of a country where the printer 100A is used and a language used in the printer 100A. The user selects a country (e.g., “Japan”) and a language (e.g., “Japanese”) in the selection region in the setting screen. In response, the printer 100A stores the selected country and language in the memory 134A.

In T14, the printer 100A executes a LAN setting. Specifically, the printer 100A first searches for a wireless network present in the vicinity of the printer 100A. Then, the printer 100A causes the display unit 114A to display a LAN setting screen (not illustrated). The LAN setting screen includes the service set identifier(s) (SSID(s)) of wireless network(s) that were found, and a password input region. The user selects the SSID of the LAN 4 to which the terminal 10 belongs and inputs a password. In response, authentication for the inputted password is executed between the printer 100A and an access point forming the LAN 4. Once the authentication succeeds, the printer 100A joins the LAN 4. As a result, the terminal 10 and the printer 100A become able to communicate with each other via the LAN 4.

In T16, the printer 100A causes the display unit 114A to display a setting start screen SC1. The setting start screen SC1 includes a QR Code 150 and a message prompting the user to capture the QR Code 150. The QR Code 150 is information obtained by encoding the URL of a web page for installing the app 42.

In response to receiving a camera activation operation from the user, the terminal 10 activates the camera 18 in T20. In T22, the user captures the QR Code 150 in the setting start screen SC1 by using the camera 18. The terminal 10 decodes the captured QR Code 150 to acquire the URL of the web page for installing the app 42. The browser 38 of the terminal 10 then uses the acquired URL to cause the display unit 14 to display the web page.

In response to the web page receiving an install operation from the user, the terminal 10 installs the app 42 in T24. In T26, the terminal 10 receives an app activation operation from the user. The app activation operation is, for example, an operation of selecting an icon of the app 42. In response to receiving the app activation operation from the user, the terminal 10 activates the app 42.

In T30, the app 42 causes the display unit 14 to display a selection screen SC2. The selection screen SC2 includes a message prompting the user to select a setup target printer and serial number(s) of setup target candidate(s). Here, the app 42 has acquired the serial number(s) of the setup target candidate(s) by searching for devices within the LAN 4. Since the printer 100A is already within the LAN 4 (T14) as described above, the selection screen SC2 includes the serial number SN1 of the printer 100A.

In T32, the app 42 receives selection of the serial number SN1 in the selection screen SC2 from the user. As a result, the printer 100A is determined as the setup target printer.

In T40, the app 42 causes the display unit 14 to display a password setting screen SC3. The password setting screen SC3 is a screen for setting a password to be used in the printer 100A. The password setting screen SC3 includes a password input region and an OK button.

In T42, the app 42 receives input of a password “XXX” in the password input region and selection of the OK button from the user. In response, the app 42 sends the inputted password “XXX” to the printer 100A in T44.

In response to receiving the password “XXX” from the terminal 10 in T44, the printer 100A stores the password “XXX” in the memory 134A in T46. The password “XXX” of the printer 100A is thereby set.

In T50, the app 42 sends the current time to the printer 100A.

In response to receiving the current time from the terminal 10 in T50, the printer 100A stores the current time in the memory 134A in T52. The time setting for the printer 100A is thereby completed.

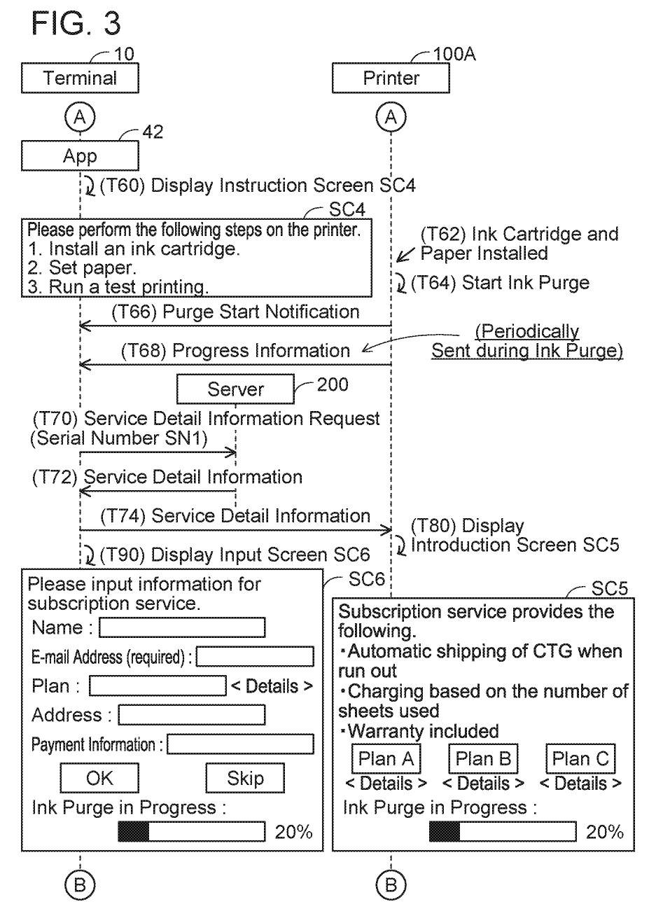

### Continuation from FIG 2: FIG 3

In T60 of FIG. 3, the app 42 causes the display unit 14 to display an instruction screen SC4. As illustrated in FIG. 3, the instruction screen SC4 includes information on what the user should do to the printer 100A. Specifically, in this embodiment, the instruction screen SC4 includes information instructing the user to (1) set an ink cartridge, (2) set paper, and (3) run test printing.

After checking the instruction screen SC4, the user sets an ink cartridge and paper in the printer 100A in T62. Subsequently, the printer 100A starts an ink purge process in T64.

As described above, the print head 120A is filled with the priming liquid. In order to execute printing using the print executing unit 118A, replacing the priming liquid in the print head 120A with ink is required. The ink purge process is a process of discharging the priming liquid and supplying the ink in the ink cartridge into the print head 120A. Generally, the ink purge process takes a few minutes.

In response to the start of the ink purge process in T64, the printer 100A sends a purge start notification indicating the start of the ink purge process to the terminal 10 in T66.

Further, during the ink purge process, the printer 100A periodically sends progress information indicating the progress of ink purge process to the terminal 10. For example, the printer 100A sends the progress information to the terminal 10 in T68.

In response to receiving the purge start information from the printer 100A in T66, the app 42 sends a service detail information request to the server 200 in T70. The service detail information request includes the serial number SN1 of the printer 100A. The service detail information request is a signal requesting the server 200 to send service detail information.

The server 200 receives the service detail information request from the terminal 10 in T70. In response, the server 200 first specifies the model name of the printer 100A based on the serial number SN1 included in the service detail information request. The server 200 then specifies one or more service plans of the subscription service available to the printer 100A having the specified model name. In this embodiment, three service plans (i.e., Plans A to C) are specified. Then, the server 200 sends service detail information including introduction information and plan information on the three specified service plans to the terminal 10. The introduction information includes character strings for introducing the subscription service. The plan information includes names and detail information of the service plans. For example, the detail information includes, for each of the service plans, the monthly fee, upper limit of available sheets, and additional fee for excess sheets.

In response to receiving the service detail information from the server 200 in T72, the app 42 sends the service detail information to the printer 100A in T74.

In response to receiving the service detail information from the terminal 10 in T74, the printer 100A causes the display unit 114A to display an introduction screen SC5 in T80. The introduction screen SC5 includes the introduction information and the plan information included in the service detail information. The user can learn about the subscription service by viewing the introduction information in the introduction screen SC5.

The introduction screen SC5 includes three buttons corresponding to the three service plans indicated by the plan information. The user is able to know that the three service plans are available to the printer 100A by viewing the introduction screen SC5. Detail buttons are displayed in association with the three buttons below the respective three buttons. The detail buttons are for displaying detail information of the respective service plans at the terminal 10.

The introduction screen SC5 further includes the progress of the ink purge process. Specifically, the introduction screen SC5 includes a progress percentage of the ink purge process (e.g., 20%) and a bar object indicating the progress percentage. A black-filled portion of the bar object corresponds to the progress percentage. The user can check the progress of the ink purge process by viewing the introduction screen SC5. As the progress of the ink purge process changes, the printer 100A updates the progress in the introduction screen SC5.

In response to sending the service detail information to the printer 100A in T74, the app 42 causes the display unit 14 to display an input screen SC6 in T90. The input screen SC6 is a screen for input of subscription information used to subscribe to the subscription service. The input screen SC6 includes a message prompting the user to input subscription information and a plurality of input regions corresponding to a plurality of items. In this embodiment, the plurality of items includes “name”, “email address”, “plan”, “address”, and “payment information”.

The input region corresponding to the item “name” is for input of the name of user subscribing to the subscription service. The input region corresponding to the item “email address” is for input of an email address used by the user. The input region corresponding to the item “plan” is for input of a service plan that the user wishes to use. Specifically, in the input region corresponding to the item “plan”, the user can select one service plan from among the three service plans indicated by the plan information. The input region corresponding to the item “address” is for input of an address of the user. The address inputted in this input region is used, for example, as the address to which an ink cartridge is delivered and/or the billing address. In a modification, the input screen SC6 may include an input region for input of a delivery address and an input region for input of a billing address separately. The input region corresponding to the item “payment information” is for input of information for payment of the subscription service fee (e.g., a credit card number).

A detail button is displayed in association with the input region corresponding to the item “plan”. This detail button is a button for displaying detail information of the service plan selected in the input region at the printer 100A. When no plan is selected in the input region, the detail button may be displayed in an unselectable manner.

The input screen SC6 further includes the progress of the ink purge process. This progress indicates the progress of the ink purge process indicated by the latest progress information received from the printer 100A. The user can check the progress of the ink purge process by viewing the input screen SC6. Every time the app 42 receives progress information from the printer 100A, the app 42 updates the progress in the input screen SC6 by using the received progress information.

As described above, in response to receiving the purge start notification from the printer 100A (T66), the app 42 acquires service-related information (T70 and T72) and displays the input screen SC6 (T90). That is, the purge start notification can be regarded as information used to cause the terminal 10 to display the input screen SC6.

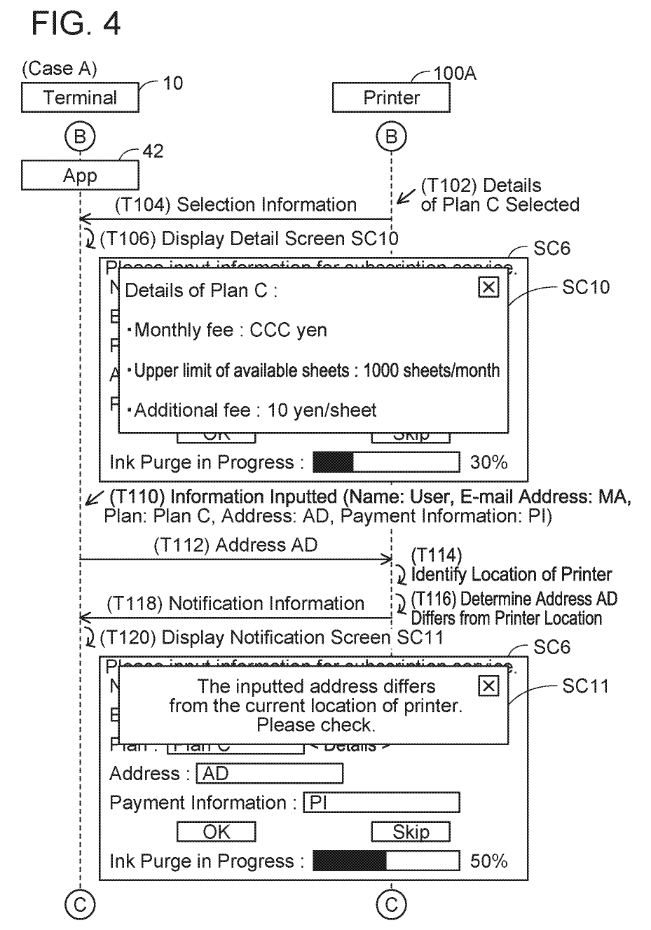

### Case A: FIGS. 4 to 6

Now referring to FIGS. 4 to 6, Case A is described. FIG. 4 illustrates a process continued from FIG. 3. In T102 of FIG. 4, the printer 100A receives selection of the detail button for Plan C in the introduction screen SC5. In response, the printer 100A sends selection information indicating the selection of Plan C to the terminal 10 in T104.

The app 42 receives the selection information from the printer 100A in T104. In response, the app 42 causes the display unit 14 to display a detail screen SC10 over the input screen SC6 in T106. Specifically, the app 42 first specifies detail information corresponding to Plan C from among the service detail information based on the selection information indicating the selection of Plan C. The app 42 then cause the display unit 14 to display the detail screen SC10 including the detail information corresponding to Plan C over the input screen SC6. That is, the selection information in T104 can be regarded as information used to cause the terminal 10 to display the detail screen SC10 including the detail information for Plan C. The user can check the details of selected Plan C by viewing the detail screen SC10. It should be noted that the detail screen SC10 is displayed over the input regions in the input screen SC6 but is not displayed over the progress of ink purge process. Thus, the user can check the progress of ink purge process even while the detail screen SC10 is being displayed over the input screen SC6.

Here, reasons why detail information is displayed not at the printer 100A but at the terminal 10 in response to the printer 100A receiving selection of a detail button are explained. In case the terminal 10 is a portable terminal device such as a smartphone, the user most likely operates the terminal 10 near the printer 100A, because the user is setting up the printer 100A using the terminal 10. Thus, the user can view the detail screen SC10 displayed on the terminal 10 while viewing the introduction screen SC5 displayed on the printer 100A. That is, the user can almost simultaneously view the introduction of the subscription service and the detail information of selected plan. Thus, user convenience is improved. In case the terminal 10 is, for example, a PC, the display area of the display unit 14 of the terminal 10 is generally larger than that of the display unit 114A of the printer 100A. Thus, displaying detailed information on the display unit 14 of the terminal 10 allows the user to easily view the detailed information of service plan.

After receiving an operation of closing the detail screen SC10 from the user, the app 42 receives input of information to each input region in the input screen SC6 in T110. Specifically, the app 42 receives input of a name “User”, an email address “MA”, a plan “Plan C”, an address “AD”, and payment information “PI” from the user. In response to receiving the input of address “AD” from the user, the app 42 sends the address “AD” to the printer 100A in T112.

The printer 100A receives the address “AD” from the terminal 10 in T112. In response, the printer 100A specifies the installation location where the printer 100A is installed in T114. Specifically, the printer 100A specifies the installation location, for example, using a global positioning system (GPS). In a modification, the printer 100A may roughly specify its installation location, for example, using the global IP address assigned to the LAN 4 to which the printer 100A belongs.

In the present case, the printer 100A determines in T116 that the received address AD is different from the specified installation location. In this case, the printer 100A sends notification information to the terminal 10 in T118. The notification information is information used to notify the user that the address “AD” inputted by the user is different from the installation location of the printer 100A.

The app 42 receives the notification information from the printer 100A in T118. In response, the app 42 displays a notification screen SC11 over the input screen SC6 in T120. That is, the notification information can be regarded as information used to cause the terminal 10 to display the notification screen SC11. The user may mistakenly input the address “AD”, or may intentionally input an address “AD” different from the installation location of the printer 100A. In the former case, the user can input the correct address after viewing the notification screen SC11. The latter case may include the installation location of the printer 100A being different from a place where shipped ink cartridges are stored. In the latter case, the user does not have to input another address. The following description is based on the latter case. That is, the user does not input another address after viewing the notification screen SC11.

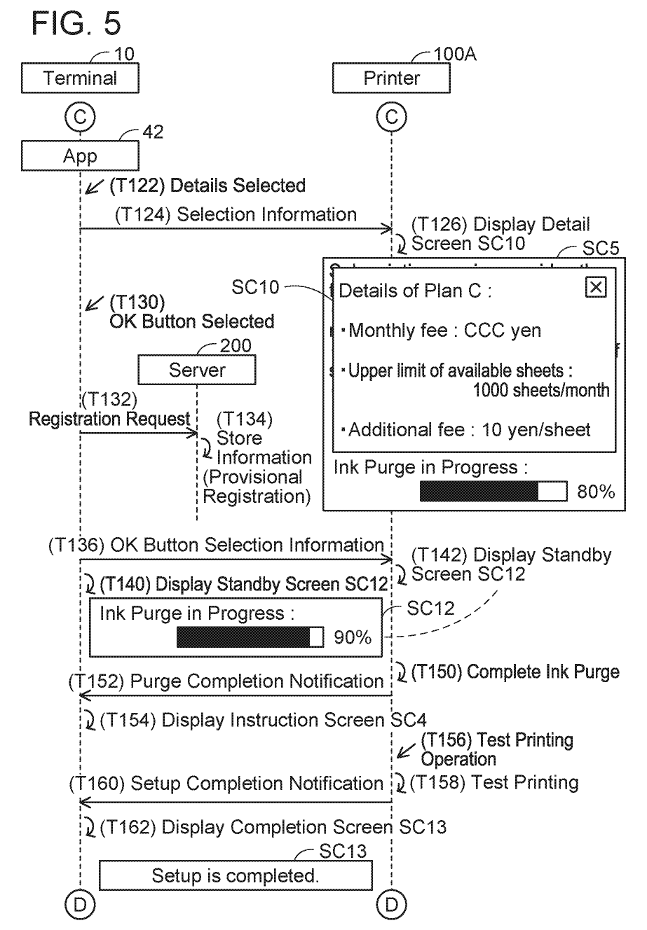

### Continuation from FIG. 4: FIG. 5

In T122 of FIG. 5, the app 42 receives selection of the detail button from the user while Plan C is selected in the input region corresponding to the item “plan”. In response, the app 42 sends selection information indicating that the detail button was selected with Plan C inputted, to the printer 100A in T124.

The printer 100A receives the selection information from the terminal 10 in T124. In response, the printer 100A causes the display unit 114A to display the detail screen SC10 over the introduction screen SC5 in T126. Specifically, the printer 100A first specifies detail information corresponding to Plan C from among the service detail information based on the selection information. The printer 100A then causes the display unit 114A to display the detail screen SC10 including the detail information corresponding to Plan C over the introduction screen SC5. That is, the selection information in T124 can be regarded as information used to cause the printer 100A to display the detail screen SC10 including the detail information corresponding to Plan C. The user can check the details of selected Plan C by viewing the detail screen SC10. It should be noted that the detail screen SC10 is displayed over the introduction information and the three buttons in the introduction screen SC5 but is not displayed over the progress of ink purge process. Thus, the user can check the progress of ink purge process even while the detail screen SC10 is being displayed over the introduction screen SC5.

Here, reasons why detail information is displayed not at the terminal 10 but at the printer 100A in response to the terminal 10 receiving selection of the detail button are explained. The timing at which the terminal 10 receives selection of the detail button is most likely somewhere within a period during which the user is inputting information in the input screen SC6. If the detail screen SC10 is displayed over the input screen SC6 at such a timing, the user cannot continue to input information in the input screen SC6. In order to avoid such an event, the detail screen SC10 is displayed on the printer 100A. In case the terminal 10 is a portable terminal device such as a smartphone, the user can input information in the input screen SC6 displayed on the terminal 10 while viewing the detail screen SC10 displayed on the printer 100A.

The app 42 receives selection of the OK button in the input screen SC6 in T130. In response, the app 42 sends a registration request to the server 200 in T132. The registration request is a signal requesting subscription to the subscription service. The registration request includes the information inputted in T110 and identification information for identifying the terminal 10, which is the sender of the registration request. The identification information is, for example, an app ID for identifying the app 42.

The server 200 receives the registration request from the terminal 10 in T132. In response, the server 200 stores the information included in the registration request in association with each other in the memory 234 in T134. Hereinafter, storing these information in T134 is referred to as “provisional registration”.

In response to receiving selection of the OK button in T130, the app 42 further sends OK button selection information to the printer 100A in T136. In response, the app 42 causes the display unit 14 to display a standby screen SC12 in T140. The standby screen SC12 includes the progress of ink purge process.

In response to receiving the OK button selection information from the terminal 10 in T136, the printer 100A causes the display unit 114A to display a standby screen SC12 in T142. This standby screen SC12 is the same as the standby screen SC12 displayed on the terminal 10.

In T150, the ink purge process is completed in the printer 100A. The printer 100A sends a purge completion notification to the terminal 10 in T152. The purge completion notification is a signal indicating the completion of the ink purge process.

The app 42 receives the purge completion notification from the printer 100A in T152. In response, the app 42 displays the instruction screen SC4 again in T154 due to the OK button in the input screen SC6 having been selected. The user can notice that the user should run test printing in the printer 100A by viewing the instruction screen SC4.

In response to receiving test printing operation from the user in T156, the printer 100A executes test printing in T158. The test printing is a test to see whether printing can be properly executed or not. For example, the test printing is a test to see whether print quality is acceptable. For example, an image for test stored in advance in the printer 100A is printed in the test printing.

After the test printing is completed in T158, the printer 100A sends a setup completion notification to the terminal 10 in T160. The setup completion notification indicates the completion of setup for the printer 100A.

In response to receiving the setup completion notification from the printer 100A in T160, the app 42 causes the display unit 14 to display a completion screen SC13 in T162. The completion screen SC13 includes information indicating the completion of setup for the printer 100A.

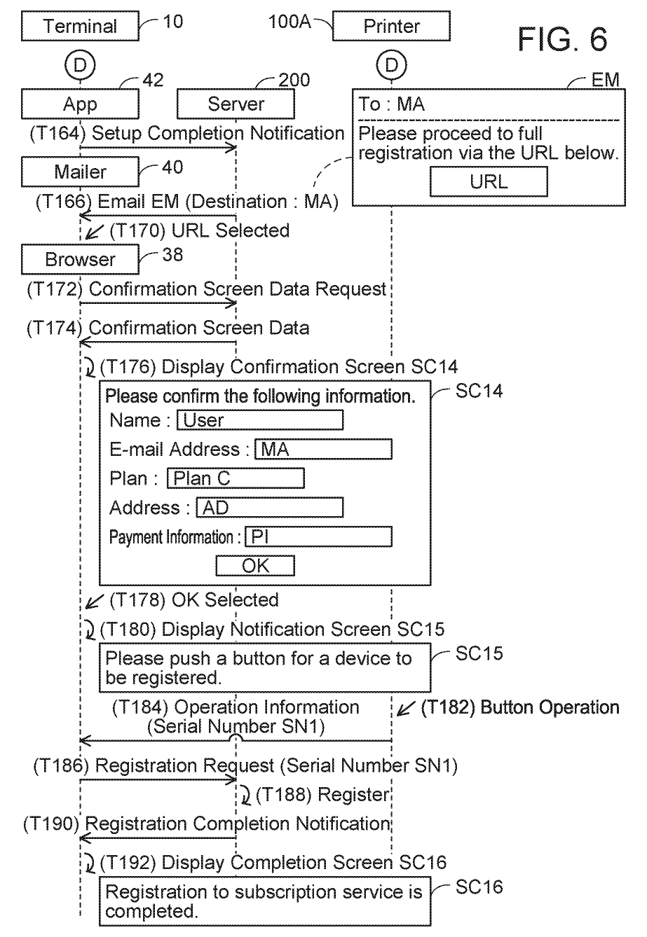

### Continuation from FIG. 5: FIG. 6

The app 42 sends a setup completion notification to the server 200 in T164 of FIG. 6 since it has sent the registration request to the server 200 in T132 of FIG. 5. The setup completion notification includes the identification information for identifying the terminal 10.

The server 200 receives the setup completion notification from the terminal 10 in T164. In response, the server 200 specifies information associated with the identification information included in the setup completion notification. That is, the server 200 specifies the information provisionally registered in T134 of FIG. 5. The server 200 then sends an email EM to the email address MA included in the specified information in T166. The email EM includes a message prompting the user to proceed to full registration and a URL representing the location of a web page for full registration. Here, “full registration” means registering a printer to which a service is to be provided in association with the provisionally registered information. The URL included in the email EM includes the identification information of the terminal 10 as a query. In a modification, this URL may include the provisionally registered information as a query, instead of the identification information of the terminal 10.

As described above, the email address MA of the user has already been set in the mailer 40 of the terminal 10. Therefore, the mailer 40 receives the email EM from the server 200 in T166. The mailer 40 then receives an operation of selecting the URL included in the email EM from the user in T170.

The selection of URL in T170 activates the browser 38. The browser 38 accesses the web page indicated by the selected URL to send a confirmation screen data request to the server 200 in T172.

The server 200 receives the confirmation screen data request from the terminal 10 in T172. In response, the server 200 specifies the provisionally registered information by using the identification information of the terminal 10 included in the URL as a query. The server 200 then sends confirmation screen data representing a confirmation screen SC14 to the terminal 10 in T174. The confirmation screen data sent in T174 includes the specified information.

In response to receiving the confirmation screen data from the server 200 in T174, the browser 38 causes the display unit 14 to display the confirmation screen SC14 in T176. The confirmation screen SC14 includes the provisionally registered information and an OK button. The user can confirm whether the information inputted in T110 of FIG. 4 are correct or not by viewing the confirmation screen SC14. Further, the user can correct wrong information, if any, in the confirmation screen SC14.

The browser 38 receives selection of the OK button in the confirmation screen SC14 from the user in T178. In response, the browser 38 causes the display unit 14 to display a notification screen SC15 in T180. The notification screen SC15 includes a message prompting the user to operate a printer to be registered as the printer to which the subscription service is to be provided.

After viewing the notification screen SC15, the user operates a predetermined button of the printer 100A in T182. In response, the printer 100A sends operation information indicating that the button was operated to the terminal 10 in T184. The operation information includes the serial number SN1 of the printer 100A.

In response to receiving the operation information from the printer 100A in T184, the browser 38 sends a registration request to the server 200 in T186. The registration request includes the serial number SN1 included in the operation information. The registration request is a signal requesting the server 200 to register the printer 100A identified by the serial number SN1 as the printer to which the service is to be provided.

In response to receiving the registration request from the terminal 10 in T186, the server 200 stores the serial number SN1 included in the registration request in association with the provisionally registered information in T188. The full registration for the subscription service is thereby completed. After the full registration for the subscription service is completed, the server 200 sends a registration completion notification to the terminal 10 in T190. Although not illustrated, after the registration for the subscription service is completed, the server 200 executes a process to ship a dedicated ink cartridge intended for use in the subscription service to the registered address.

In response to receiving the registration completion notification from the server 200 in T190, the browser 38 causes the display unit 14 to display a completion screen SC16 in T192. The completion screen SC16 includes a message indicating the completion of registration (i.e., full registration) for the subscription service. The user is able to know that the registration for the subscription service has been completed by viewing the completion screen SC16.

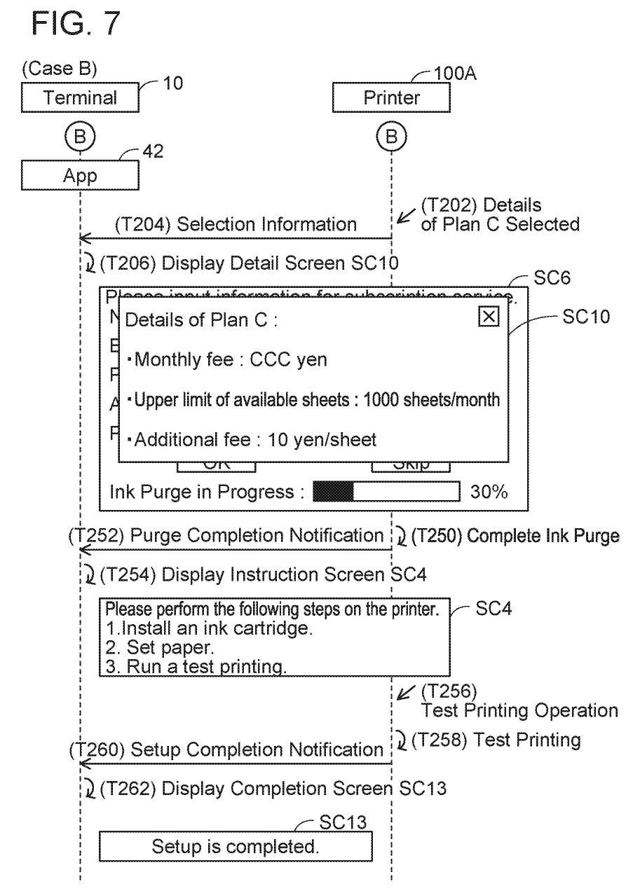

### Case B: FIG. 7

Now referring to FIG. 7, Case B is described. Case B is different from Case A in that the ink purge process is completed without any information being inputted to the input screen SC6. FIG. 7 illustrates a process continued from FIG. 3. A sequence from T202 to T206 in FIG. 7 is the same as the sequence from T102 to T106 in FIG. 4.

In Case B, the ink purge process is completed in the printer 100A in T250 without any information being inputted to the input screen SC6. In this case, the printer 100A sends a purge completion notification to the terminal 10 in T252.

The app 42 receives the purge completion notification from the printer 100A in T252. The app 42 causes the display unit 14 to display the instruction screen SC4 again in T254, since no information has been inputted to the input screen SC6 and the OK button in the input screen SC6 has not been selected. A sequence from T256 to T262 is the same as the sequence from T156 to T162 in FIG. 5.

Since the user does not input any information to the input screen SC6 in Case B, the app 42 does not send the setup completion notification to the server 200. For example, if the user does not want to subscribe to the subscription service, the user does not input information to the input screen SC6. In this case, the setup completion notification is not sent to the server 200, and thus the process for full registration for the subscription service (see FIG. 6) is not executed.

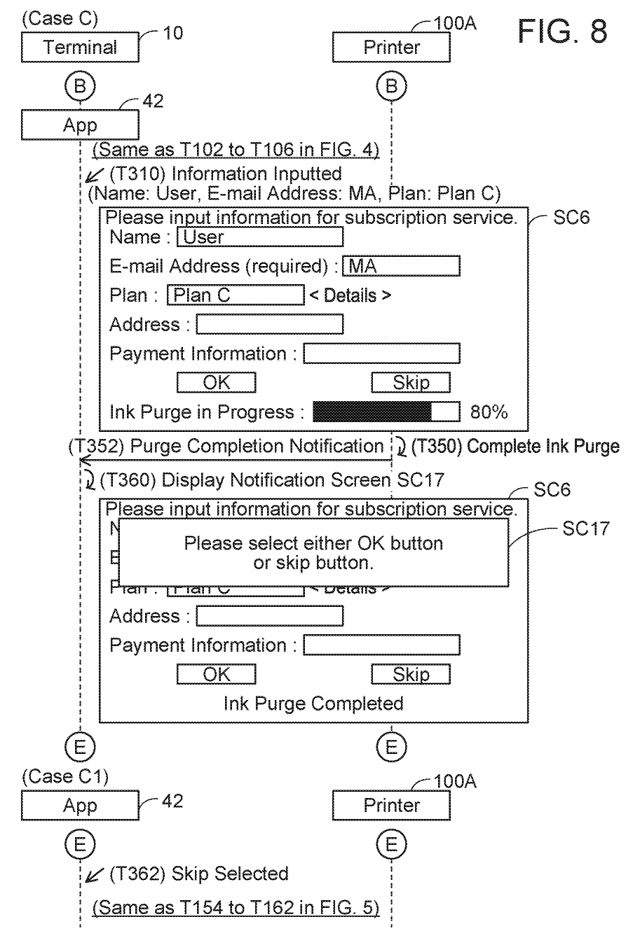

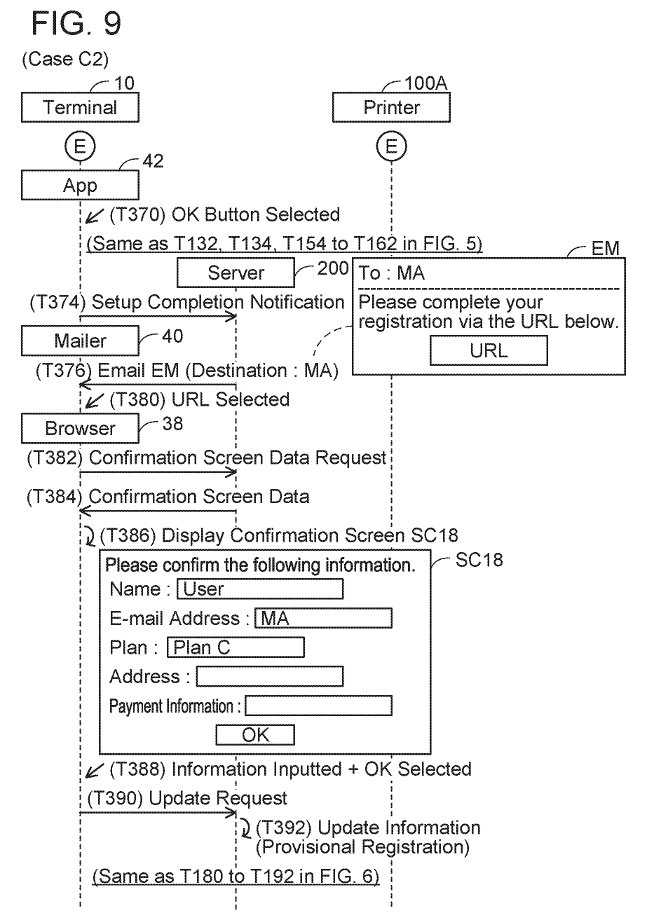

### Case C: FIGS. 8 and 9

Now referring to FIGS. 8 and 9, Case C is described. Case C is different from Case A in that the ink purge process is completed while information is being inputted to the input screen SC6. FIG. 8 illustrates a process continued from FIG. 3. In Case C, a sequence same as the sequence from T102 to T106 in FIG. 4 is executed first.

After receiving the operation of closing the detail screen SC10 (see FIG. 4), the app 42 receives input of information to the input regions in the input screen SC6 in T310. Specifically, the app 42 sequentially receives input of a name “User”, an email address “MA”, and a plan “Plan C” from the user.

While the user is inputting information to the input screen SC6, the ink purge process is completed in the printer 100A in T350. In this case, the printer 100A sends a purge completion notification to the terminal 10 in T352.

The app 42 receives the purge completion notification from the printer 100A in T352. In response, the app 42 causes the display unit 14 to display a notification screen SC17 over the input screen SC6 since some information have been inputted to the input regions and the OK button in the input screen SC6 has not been selected. The notification screen SC17 includes a message prompting the user to select the OK button or a skip button in the input screen SC6.

### Case C1: FIG. 8

First, Case C1 in which the skip button in the input screen SC6 is selected is described. The app 42 receives selection of the skip button in the input screen SC6 from the user in T362. In this case, a sequence same as the sequence from T154 to T162 in FIG. 5 is executed without a registration request including the already inputted name “User”, email address “MA”, and plan “Plan C” being sent to the server 200. In Case C1 as well, the app 42 does not send the setup completion notification to the server 200, as in Case B. Therefore, the process for full registration for the subscription service (see FIG. 6) is not executed.

### Case C2: FIG. 9

Next, Case C2 in which the OK button in the input screen SC6 is selected is described referring to FIG. 9. In T370, the app 42 receives selection of the OK button in the input screen SC6. In this case, steps same as T132, T134, and T154 to T162 in FIG. 5 are executed. However, in T132 and T134 executed in Case C2 illustrated in FIG. 9, the information inputted in T310 of FIG. 8 (i.e., the name “User”, the email address “MA”, and the plan “Plan C”) are used.

A sequence from T374 to T384 is the same as the sequence from T164 to T174 in FIG. 6 except for the information provisionally registered in the server 200. The browser 38 causes the display unit 14 to display a confirmation screen SC18 in T386. The confirmation screen SC18 is the same as the confirmation screen SC14 (see FIG. 6) except that information for the item “address” and information for the item “payment information” are not included in the confirmation screen SC18.

The browser 38 receives input of information for the items “address” and “payment information” (i.e., “AD” and “PI”) and then receives selection of the OK button in T388. In response, the browser 38 sends an update request to the server 200 in T390. The update request is a signal requesting the server 200 to update the provisionally registered information. The update request includes the information included in the confirmation screen SC18 and the identification information of the terminal 10, which is the sender of the update request.

The server 200 receives the update request from the terminal 10 in T390. In response, the server 200 updates the provisionally registered information in T392. Specifically, the server 200 first specifies information associated with the identification information included in the update request. The server 200 then updates the specified information to the information included in the update request. Subsequently, a sequence same as the sequence from T180 to T192 in FIG. 6 is executed, thereby completing the registration (i.e., full registration) for the subscription service.

### Advantageous Effects of First Embodiment

According to the configuration above, the printer 100A sends the purge start notification to the terminal 10 (T66) upon the start of the ink purge process (T64 in FIG. 3). Subsequently, the printer 100A causes the display unit 114A to display the introduction screen SC5 for introduction of the subscription service (T80). The terminal 10, in response to receiving the purge start notification from the printer 100A, causes the display unit 14 to display the input screen SC6 for input of subscription information (T90). Then, after information have been inputted to the input screen SC6, the terminal 10 sends a registration request including the inputted information to the server 200 (T132 in FIG. 5). Generally, the ink purge process takes a certain amount of time from its start to end. Since the input screen SC6 is displayed on the terminal 10 while the ink purge process is being executed, the user can input information while waiting for the ink purge process to end. Further, the user can input information to the terminal 10 after checking the introduction screen SC5 displayed on the printer 100A. Thus, user convenience can be improved.

### Correspondence Relationships

The terminal 10 and the printer 100A are examples of “terminal device” and “printer”, respectively. The app 42 is an example of “computer-readable instructions for a terminal device”. The display unit 14 of the terminal 10 and the display unit 114A of the printer 100A are examples of “terminal display unit” and “printer display unit”, respectively. The subscription service is an example of “predetermined service”. The ink purge process is an example of “print preparation process”. The purge start notification is an example of “start information” and “information indicating display of the introduction screen”. The introduction screen SC5 and the input screen SC6 are examples of “introduction screen” and “information input screen”, respectively. Each input region in the input screen SC6 is an example of “first input region”. Especially, the input region corresponding to the item “address” and the input region corresponding to the item “plan” are examples of “second input region” and “selection region”, respectively. The address is an example of “printer-related information”. The operation of selecting the detail button in the input screen SC6 is an example of “related operation”. The bar objects included in the introduction screen SC5 and the input screen SC6 are examples of “progress information display screen”. Plans A to C is an example of “one or more service plans”. Plan C is an example of “specific service plan”. The detail screen SC10 is an example of “detail screen”. The selection information in T124 of FIG. 5 is an example of “operation information”. The notification screen SC11 is an example of “notification screen”.

Correspondence relationships regarding steps executed by “computer-readable instructions for a terminal device” are as follows. T66, T68, and T90 in FIG. 3 are examples of “receive start information”, “receive progress information”, and “cause the terminal display unit to display an information input screen”, respectively. T104, T106, T112, T118, and T120 in FIG. 4 are examples of “receive selection information”, “cause the terminal display unit to display a detail screen”, “send the printer-related information”, “receive from the printer notification information”, and “cause the terminal display unit to display a notification screen”, respectively. T124 and T132 in FIG. 5 are examples of “send operation information” and “send the subscription information”, respectively.

Correspondence relationships regarding steps executed by the “printer” are as follows. T64, T66, and T80 in FIG. 3 are examples of “cause the print executing unit to execute a print preparation process”, “send start information”, and “cause the printer display unit to display an introduction screen

”, respectively. T104, T112, and T118 in FIG. 4 are examples of “send selection information”, “receive the printer-related information”, and “send notification information”, respectively. T124 and T126 in FIG. 5 are examples of “receive operation information” and “cause the printer display unit to display a detail screen”, respectively.

T90 in FIG. 3 and T132 in FIG. 5 are examples of “cause the terminal display unit to display an information input screen” and “send the subscription information” by the “printer”, respectively.

### Second Embodiment

Now, a second embodiment is described. In the second embodiment, a laser printer 100B is used instead of the inkjet printer 100A.

### Configuration of Printer 100B: FIG. 1

The printer 100B is a peripheral device configured to execute a print function (e.g., a peripheral device of the terminal 10). In a modification, the printer 100B may be a multifunctional device configured to execute a scan function and/or a facsimile function in addition to the print function. A serial number SN2, which is identification information for identifying the printer 100B, is assigned to the printer 100B. The printer 100B comprises an operation unit 112B, a display unit 114B, a communication I/F 116B, a print executing unit 118B, and a controller 130B. The units 112B to 130B are connected to a bus line. The units 112B to 116B and 130B have the same configurations as the units 112A to 116A and 130A of the printer 100A, respectively.

The print executing unit 118B comprises a laser print engine. A toner cartridge containing toner is detachably mounted to the print executing unit 118B. The print executing unit 118B comprises a photoreceptor 120B and an exposure device 122B. The photoreceptor 120B is a drum that transfers the toner onto print paper. The exposure device 122B emits laser light to the photoreceptor 120B.

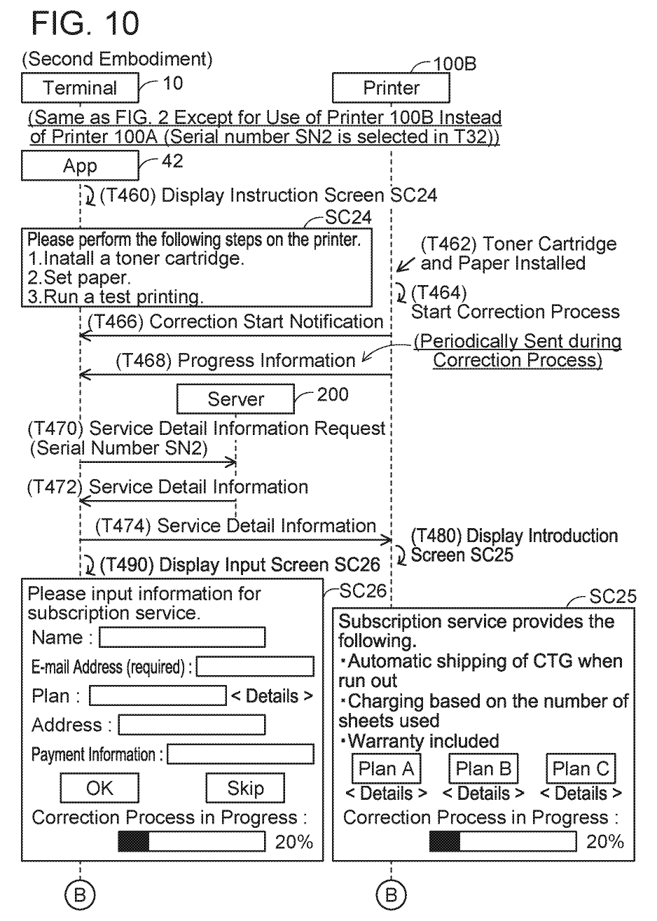

### Process Executed Between Devices: FIG. 10

Now referring to FIG. 10, a process executed between the devices is described. In the second embodiment, the same steps as those illustrated in FIG. 2 are first executed except for the use of the printer 100B instead of the printer 100A. Especially, in T32 executed in FIG. 10, the app 42 receives selection of the serial number SN2 in the selection screen SC2.

In T460 of FIG. 10, the app 42 causes the display unit 14 to display an instruction screen SC24. As illustrated in FIG. 10, the instruction screen SC24 includes information on what the user should do to the printer 100B. Specifically, in this embodiment, the instruction screen SC24 includes information instructing the user to (1) set a toner cartridge, (2) set paper, and (3) run test printing.

After viewing the instruction screen SC24, the user sets a toner cartridge and paper in T462. In response, the printer 100B starts a correction process in T464.

The printer 100B forms images by scanning the laser light, emitted from the exposure device 122B to the photoreceptor 120B, in a main-scanning direction and a sub-scanning direction. The main-scanning direction is a direction in which print paper is conveyed in the printer 100B, and the sub-scanning direction is perpendicular to the main-scanning direction. For example, when the internal temperature of the exposure device 122B rises, the actual position irradiated with the laser light emitted from the exposure device 122B (referred to as “actual laser-irradiation position”) may deviate from the target position intended to be irradiated with the laser light (referred to as “target laser-irradiation position”). The deviation of the actual laser-irradiation position may cause color misalignment, thereby degrading the quality of image formed by the printer 100B. The correction process is a process for correcting the displacement of the actual laser-irradiation position. In this embodiment, the printer 100B measures actual laser-irradiation positions until the inside of the exposure device 122B reaches a high temperature. Thereby, the printer 100B can recognize which direction the actual laser-irradiation position is displaced. The printer 100B corrects the target laser-irradiation position such that the displacement of the actual laser-irradiation position can be suppresses. The correction process is not limited to being executed by the above-described method, and a variety of known methods may be used. Generally, the correction process takes a few minutes.

After starting the correction process in T464, the printer 100B sends a correction start notification indicating the start of the correction process to the terminal 10 in T466.

Further, during the correction process, the printer 100B periodically sends progress information indicating the progress of the correction process to the terminal 10. For example, the printer 100B sends the progress information to the terminal 10 in T468.

T470 is the same as T70 in FIG. 3 except that the service detail information request in T470 includes the serial number SN2 of the printer 100B. T472 and T474 are the same as T72 and T74 in FIG. 3 except for contents of the service detail information.

In T480, the printer 100B causes the display unit 114B to display an introduction screen SC25. The introduction screen SC25 is the same as the introduction screen SC5 (see FIG. 3) except for contents of the introduction information and plan information, and its inclusion of the progress of correction process instead of the progress of ink purge process.

In T490, the app 42 causes the display unit 14 to display an input screen SC26. The input screen SC26 is the same as the input screen SC6 (see FIG. 3) except for its inclusion of the progress of correction process instead of the progress of ink purge process. The following steps are the same as those illustrated in FIGS. 4 to 8 except for the use of the printer 100B instead of the printer 100A. The second embodiment also improves user convenience as with the first embodiment. The printer 100B is an example of “printer”. The correction process is an example of “print preparation process”. T464 in FIG. 10 is an example of “cause the print executing unit to execute a print preparation process ” by the “printer”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Modification 1) In case information are inputted to the input regions corresponding to the items in T110 of FIG. 4, the app 42 may send the registration request to the server 200 without receiving selection of the OK button.

(Modification 2) Both the introduction screen SC5 and the input screen SC6 may not include the bar object indicating the progress of ink purge process. Especially, in this modification, the printer 100A may not send the progress information indicating the progress of ink purge process to the terminal 10. In this modification, the “computer-readable instructions for a terminal device” may not cause the “terminal device” to “receive progress information”. Further, the “computer-readable instructions for a terminal device” may not cause the “terminal display unit” to display the “progress information display screen”. Further, in this modification the “printer” may not cause the printer display unit to display the “progress information display screen”.

(Modification 3) Each of the introduction screen SC5 and the input screen SC6 may include, for example, a circle chart indicating a progress percentage of the ink purge process instead of the bar objects indicating the progress of ink purge process. In this modification, these circle charts are examples of “progress information display screen”. In another modification, each of the introduction screen SC5 and the input screen SC6 may include only a character string (e.g., “20%”) indicating a progress percentage of the ink purge process. In this modification, the character strings are examples of “progress information display screen”. Generally, the “progress information display screen” may be a screen in any form as long as it indicates progress information indicating the progress of print preparation process.

(Modification 4) T104 and T106 in FIG. 4 may be omitted. In this case, for example, the printer 100A may cause the display unit 114A to display the detail screen SC10 in response to receiving selection of the detail button corresponding to Plan C in T102. In this modification, the “computer-readable instructions for a terminal device” may not cause the “terminal device” to “receive selection information

” nor “cause the terminal display unit to display a detail screen”. Further, in this modification, “send selection information” by the “printer” may be omitted.

(Modification 5) In T106 of FIG. 4, the detail screen SC10 may be displayed over the bar object indicating the progress of ink purge process included in the input screen SC6. In another modification, the detail screen SC10 may not be displayed over the input screen SC6.

(Modification 6) T124 and T126 in FIG. 5 may be omitted. In this case, for example, the app 42 may cause the display unit 14 to display the detail screen SC10 in response to receiving selection of the detail button in T122. In this modification, the “computer-readable instructions for a terminal device” may not cause the “terminal device” to “send operation information”. Further, in this modification, “receive operation information” and “cause the printer display unit to display a detail screen” may be omitted.

(Modification 7) In case one service plan is selected in the input region corresponding to the item “plan” in T110 of FIG. 4, the app 42 may execute the step of T124 in FIG. 5. In this modification, the operation of selecting one service plan in the input region corresponding to the item “plan” is an example of “related operation”.

(Modification 8) In T126 of FIG. 5, the detail screen SC10 may be displayed over the bar object indicating the progress of ink purge process included in the introduction screen SC5. In another modification, the detail screen SC10 may not be displayed over the introduction screen SC5.

(Modification 9) T112 to T120 in FIG. 4 may be omitted. In this modification, the “computer-readable instructions for a terminal device” may not cause the “terminal device” to “send the printer-related information”, “receive from the printer notification information”, nor “cause the terminal display unit to display a notification screen. Further, in this modification, “receive the printer-related information” and “send notification information” by the “printer” may be omitted.

(Modification 10) The input screen SC6 may include one or more input regions corresponding to one or more items different from the items described in the above embodiments. For example, the input screen SC6 may include an input region corresponding to a model name of setup-target printer. In case a model name is inputted to this input region in T110 of FIG. 4, the app 42 may send the model name to the printer 100A. The printer 100A may determine whether the received model name matches the model name of the printer 100A stored in the memory 134A. In case the model names do not match, the printer 100A may send notification information indicating that the inputted model name is different from the model name of the printer 100A to the terminal 10. In this modification, the model name is an example of “printer-related information”.

(Modification 11) The subscription service may include, for example, a usage-based print service instead of the flat-rate print service. The usage-based print service charges fees based on the number of print media used within a predetermined period. In this modification, the subscription service including the usage-based print service is an example of “predetermined service”. Generally, the “predetermined service” may be any service as long as it is a printer-related service.

(Modification 12) In the embodiments above, the steps in FIGS. 2 to 10 are executed by software (e.g., the OS 36, the browser 38, the mailer 40, the app 42, the programs 136A, 136B, 236), however, at least one of these steps may be executed by hardware such as a logic circuit.

What is claimed is:

1. A non-transitory computer-readable storage medium storing computer-readable instructions for a terminal device,
wherein the terminal device comprises:
a terminal display unit; and
a processor,
wherein the computer-readable instructions, when executed by the processor, cause the terminal device to:
in a case where a print preparation process is started in a printer, receive start information indicating start of the print preparation process from the printer;
in a case where the start information is received from the printer, cause the terminal display unit to display an information input screen for input of subscription information, the subscription information being used to subscribe to a predetermined service related to the printer; and
in a case where the subscription information is inputted in the information input screen, send the subscription information to a server.

2. The non-transitory computer-readable storage medium according to claim 1, wherein the computer-readable instructions, when executed by the processor, further cause the terminal device to receive progress information indicating a progress of the print preparation process from the printer, and
wherein the terminal display unit is caused to display a progress information display screen indicating the progress information along with the information input screen.

3. The non-transitory computer-readable storage medium according to claim 1,
wherein an introduction screen for introduction of the predetermined service is displayed on a printer display unit of the printer while the information input screen is being displayed, and
the introduction screen indicates one or more service plans available in the predetermined service,
wherein the computer-readable instructions, when executed by the processor, further cause the terminal device to:
in a case where a specific service plan is selected from among the one or more service plans indicated on the introduction screen, receive selection information indicating selection of the specific service plan from the printer; and
in a case where the selection information is received from the printer, cause the terminal display unit to display a detail screen indicating detail information of the specific service plan.

4. The non-transitory computer-readable storage medium according to claim 3,
wherein the computer-readable instructions, when executed by the processor, further cause the terminal device to receive progress information indicating a progress of the print preparation process from the printer,
wherein the information input screen includes a first input region for input of the subscription information,
the terminal display unit is caused to display a progress information display screen indicating the progress information along with the information input screen, and
the detail screen is displayed over the first input region but is not displayed over the progress information display screen.

5. The non-transitory computer-readable storage medium according to claim 1,
wherein the information input screen includes a selection region for selection of one service plan from among one or more service plans available in the predetermined service,
wherein the computer-readable instructions, when executed by the processor, further cause the terminal device to, in a case where a related operation related to a specific service plan among the one or more service plans is performed in the selection region, send operation information indicating that the related operation has been performed to the printer, the operation information being used to cause a printer display unit of the printer to display a detail screen indicating detail information of the specific service plan.

6. The non-transitory computer-readable storage medium according to claim 1,
wherein the information input screen includes a second input region for input of printer-related information which is related to the printer and included in the subscription information,
wherein the computer-readable instructions, when executed by the processor, further cause the terminal device to:
in a case where the printer-related information is inputted in the second input region, send the printer-related information to the printer;
in a case where the printer-related information is determined to be wrong at the printer, receive from the printer notification information indicating that the printer-related information is wrong; and
in a case where the notification information is received from the printer, cause the terminal display unit to display a notification screen indicating that the printer-related information is wrong.

7. A printer comprising:
a print executing unit;
a printer display unit; and
a controller,
wherein the controller is configured to:
cause the print executing unit to execute a print preparation process;
in a case where the print preparation process is started by the print executing unit, cause the printer display unit to display an introduction screen for introduction of a predetermined service which is related to the printer; and
in the case where the print preparation process is started by the print executing unit, send start information indicating start of the print preparation process to a terminal device, wherein the start information is used to cause a terminal display unit of the terminal device to display an information input screen for input of subscription information, the subscription information being used to subscribe to the predetermined service.

8. The printer as in claim 7,
wherein the controller is configured to cause the printer display unit to display a progress information display screen that includes progress information indicating a progress of the print preparation process, along with the introduction screen.

9. The printer as in claim 7,
wherein the introduction screen indicates one or more service plans available in the predetermined service,
the controller is further configured to, in a case where a specific service plan is selected from among the one or more service plans indicated in the introduction screen, send selection information indicating selection of the specific service plan to the terminal device, the selection information being used to cause the terminal display unit to display a detail screen indicating detail information of the specific service plan.

10. The printer as in claim 7,
wherein the information input screen includes a selection region for selection of one service plan from among one or more service plans available in the predetermined service,
wherein the controller is further configured to:
in a case where a related operation which is related to a specific service plan among the one or more service plans is performed in the selection region, receive operation information indicating that the related operation has been performed from the terminal device; and
in a case where the operation information is received from the terminal device, cause the printer display unit to display a detail screen indicating detail information of the specific service plan.

11. The printer as in claim 10,
wherein the introduction screen indicates introduction information introducing the predetermined service,
wherein the controller is configured to cause the printer display unit to display a progress information display screen that includes progress information indicating a progress of the print preparation process, along with the introduction screen, and
the detail screen is displayed over the introduction information but is not displayed over the progress information display screen.

12. The printer as in claim 7,
wherein the information input screen includes an input region for input of printer-related information which is related to the printer and included in the subscription information,
wherein the controller is further configured to:
in a case where the printer-related information is inputted in the input region, receive the printer-related information from the terminal device; and
in a case where the printer determines that the printer-related information is wrong, send notification information indicating that the printer-related information is wrong to the terminal device, the notification information being used to cause the terminal display unit to display a notification screen indicating that the printer-related information is wrong.

13. The printer as in claim 7, wherein
the printer is an inkjet printer,
the print executing unit comprises a print head configured to eject ink,
the print head is filled with a priming liquid before the print head is filled with the ink, and
the print preparation process includes a process of discharging the priming liquid from the print head to fill the print head with the ink.

14. The printer as in claim 7, wherein
the printer is a laser printer,
the print executing unit comprises a photoreceptor and an exposure device configured to emit laser light to the photoreceptor, and
the print preparation process includes a process of correcting a displacement of a position irradiated with the laser light emitted from the exposure device to the photoreceptor.

15. A communication system comprising:
a printer; and
a terminal device,
wherein the printer comprises:
a printer display unit; and
a printer controller configured to cause the printer display unit to display an introduction screen for introduction of a predetermined service related to the printer,
wherein the terminal device comprises:
a terminal display unit; and
a terminal controller,
wherein the terminal controller is configured to:
in a case where information indicating display of the introduction screen on the printer display unit is received from the printer, cause the terminal display unit to display an information input screen for input of subscription information, the subscription information being used to subscribe to the predetermined service; and
in a case where the subscription information is inputted in the information input screen, send the subscription information to a server.
